(19) United States
(12) Patent Application Publication
(10) Pub. No.: US 2015/0355392 A1
(43) Pub. Date: Dec. 10, 2015

(54) Sun-Reflective Panel Useful For Melting Ice or Snow

(71) Applicant: Jean Muscat, McHenry, IL (US)

(72) Inventor: Jean Muscat, McHenry, IL (US)

(21) Appl. No.: 14/296,086

(22) Filed: Jun. 4, 2014

(51) Int. Cl. G02B 5/10; E04D 13/064

(52) U.S. Cl. CPC G02B 5/10; E04D 13/064

(57) ABSTRACT

A device for directing sunlight towards snow or ice including a panel member configured for attachment to a structure of a building, where the panel member has a reflective surface suitable for reflecting sunlight, said reflective surface having a curved configuration adapted for directing sunlight towards an adjacent road surface for melting snow or ice on the road surface.

BACKGROUND

The present application generally relates to a device and method for melting snow or ice. More particularly, the present application relates to a device and method including a reflective panel for directing sunlight towards snow or ice.

During the winter months, many parts of the country, particularly the northern states, experience periodic snowfalls. Commercial businesses often hire snow removal contractors to plow the snow off of the road surfaces around the buildings of the business. However, snowplows are unable to remove all of the snow, as a thin layer of snow remains and snow becomes piled up at the edges of the road surface. Therefore, some snow remains, and often snow is pushed towards, and piles up against, buildings on the property during the plowing process.

Where road surfaces are exposed to direct sunlight during the course of the day, the sunlight may cause the snow to melt. However, where road surfaces are not exposed to direct sunlight, the snow may remain until temperatures rise above freezing. Further, where the road surfaces are only exposed to sunlight for a limited period of time, the snow may partially melt and turn to ice when a shadow moves over the area, or during the night. Such conditions may occur where adjacent buildings are positioned close together. As a result, often snow and/or ice remain on the road surfaces creating an undesirable condition.

Having snow and ice remain on the road surfaces is particularly undesirable in the case of self-storage buildings. Self-storage buildings may include a series of buildings positioned adjacent to one another, sometimes with a 20 foot wide aisle between buildings, and often with the buildings having a length of 100-300 feet. Because of the close proximity of the buildings, snow and ice may build up in front of the storage units, making it difficult for customers to access their storage unit. Furthermore, it may be difficult to customers to traverse the snow and ice in front of their units when adding items to, or removing from, the storage unit.

Accordingly, it would be desirable to provide a device and method for melting the snow and/or ice that accumulates on road surfaces, and particularly on the aisles between respective buildings of a self-storage facility.

### SUMMARY

In one aspect, a device for directing sunlight towards snow or ice is provided including a panel member configured for attachment to a structure of a building, where the panel member has a reflective surface suitable for reflecting sunlight, said reflective surface having a curved configuration adapted for directing sunlight towards an adjacent road surface for melting snow or ice on the road surface.

In a further aspect, a reflective gutter system is provided having a gutter secured to a building structure, a panel member having a top end secured to the gutter of the building, where said panel member has a reflective surface suitable for reflecting sunlight, where said reflective surface has a curved configuration adapted for directing sunlight towards an adjacent road surface for melting snow or ice on the road surface.

In a further aspect, a method of directing sunlight towards a road surface is provided including the steps of providing a panel member configured for attachment to a structure of a building, said panel member having a reflective surface suitable for reflecting sunlight, and said reflective surface having a curved configuration adapted for directing sunlight towards an adjacent road surface for melting snow or ice on the road surface; securing the panel about a gutter on the structure of the building; and directing sunlight towards snow or ice positioned on a road surface positioned adjacent the building.

In a further aspect, means for melting snow or ice on a road surface adjacent a structure of a building using a sun-reflective panel mounted on the structure of the building is provided.

### BRIEF DESCRIPTION OF THE DRAWINGS

Exemplary embodiments of the invention are described herein with reference to the drawings, wherein like parts are designated by like reference numerals, and wherein:

FIG. 1 is a perspective view with of a storage facility 10, according to an example embodiment;

FIG. 2 is a perspective view illustrating sunlight being reflected off of a sun-reflective panel 300 on building 200 towards road surface 30 of storage facility 10 shown in FIG. 1, according to an example embodiment;

FIG. 3 is a close up view of building 200 including sun-reflective panel section 300, according to an example embodiment;

FIG. 4 is another perspective view of storage facility 10 showing snow 40 and ice 50 positioned within shadow 60 on road surface 30 shown in FIG. 1;

FIG. 5 is a perspective view of building 200 having sun-reflective panel 300 positioned thereon, according to an example embodiment;

FIG. 6 is a cross-sectional view of a gutter system 204; according to an example embodiment; and

FIG. 7 is a close up cross-sectional view showing sun-reflective panel 300 positioned over gutter system 204, according to an example embodiment.

### DETAILED DESCRIPTION

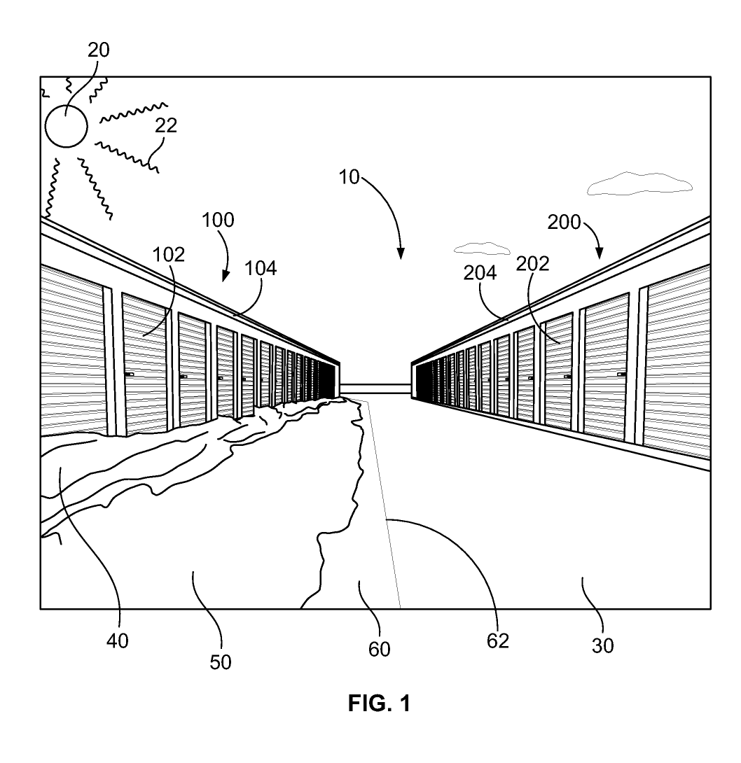

FIG. 1 illustrates a perspective view of a self-storage facility 10 shown having building 100 adjacent building 200 with road surface 30 positioned therebetween. Building 100 includes storage unit doors 102 and gutter 104 and building 200 includes storage unit doors 202 and gutter 204. The road surface 30 forms an aisle between building 100 and 200, and typically has width of around 20 feet which is wide enough to allow two vehicles to pass each other, but narrow enough so that a number of adjacent buildings may be erected on the storage facility property.

As will be appreciated, sunlight 22 from sun 20 often does not shine directly onto the entirety of road surface 30, and may only do so when the sun is directly overhead. However, most often sunlight from sun 20 is blocked by building 100 or 200 and a shadow is cast over part or over all of the road surface 30. In particular, as illustrated in FIG. 1, sunlight 22 coming from the low angle of winter sun 20 is blocked by building 100, and a shadow 60 having an edge 61 is cast over part of road surface 30, in front of building 100 which may be northward facing. In this example, the portion of road surface 30 exposed to direct sunlight in front of south facing building 200 is free of snow and ice. However, the area of road surface 30 positioned within shadow 60 is still covered with ice 50 and snow 40 which is piled up adjacent to storage unit doors 102. It is undesirable to have snow 40 or ice 50 remaining on the road surface 30, as it increases the difficulty of a storage unit customer from adding items to, or removing items from, their storage unit.

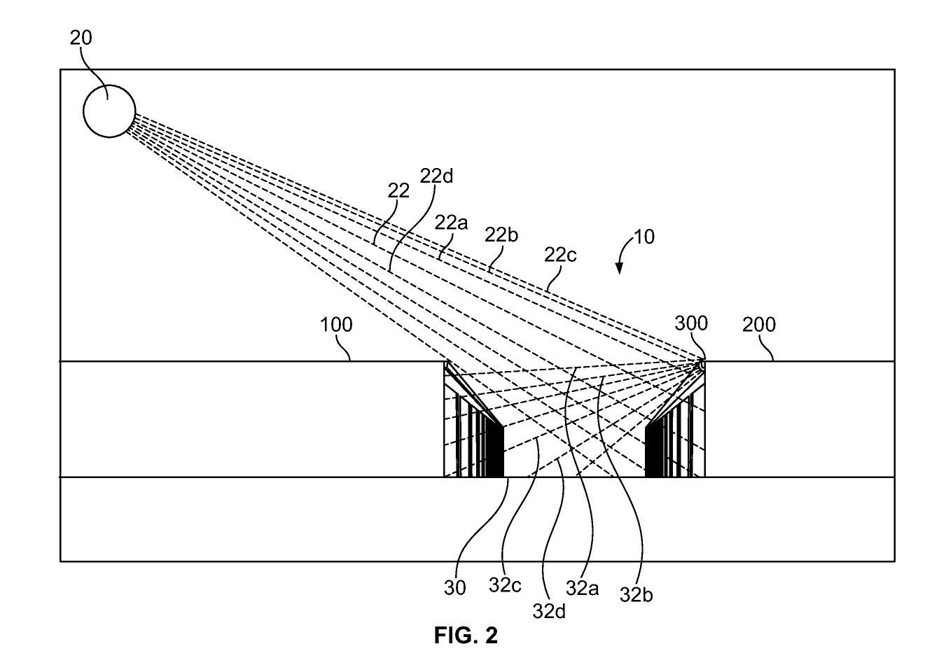

Example embodiments are directed to a reflective panel that may be mounted on the existing gutter of a building to direct sunlight towards a road surface adjacent the building. As illustrated in FIG. 2, a reflective panel 300 has been mounted over the gutter on the roof of building 200 of self-storage facility 10. Rays of sunlight 22 and 22a-22d from sun 20 reflect off of reflective panel 300 as rays 32a-d and are directed towards road surface 30 and building 100.

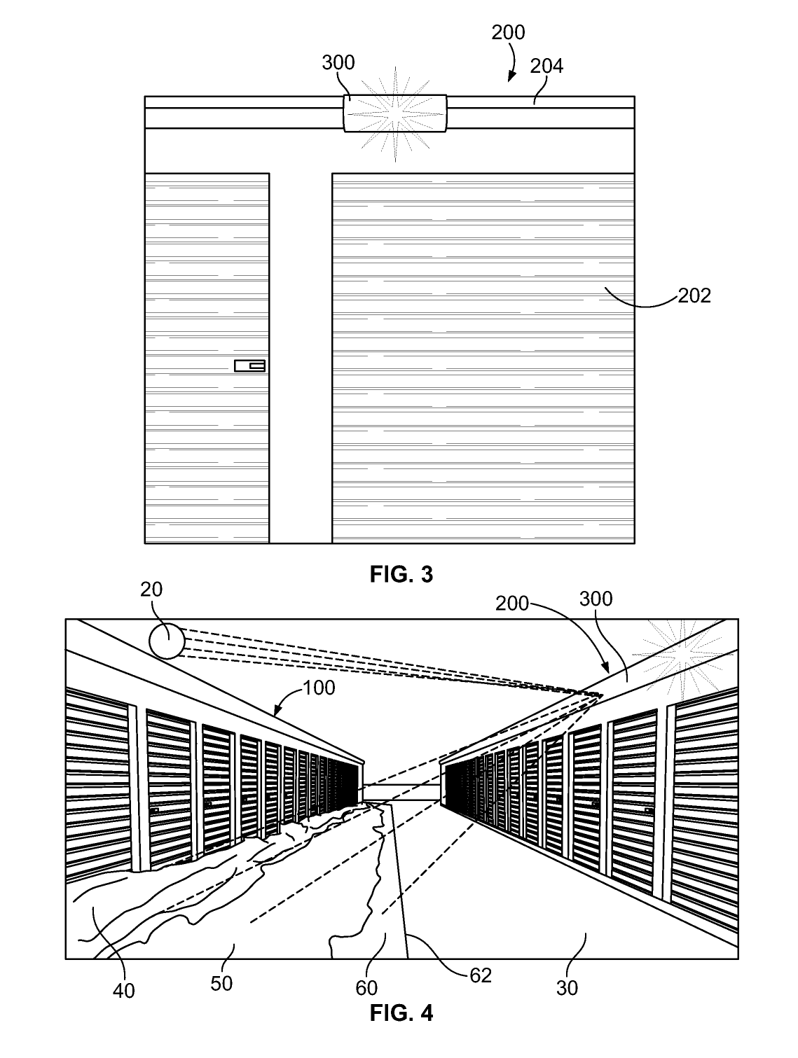

FIG. 3 is a close up view of building 200 including a section of sun-reflective panel 300 positioned over gutter 204, which is at the top of building 200 above storage unit door 202. FIG. 4 is another perspective view of storage facility 10 showing snow 40 and ice 50 positioned within shadow 60 on road surface 30 in front of building 100. In this embodiment, the reflective panel 300 is positioned along the entire length of the gutter of building 200. Rays of sunlight from sun 20 reflect off of reflective panel 300 and are directed towards the snow 40 and ice 50 within shadow 60 in front of building 100. The sunlight reflected off of reflective panel 300 and directed towards snow 40 and ice 50 in front of building 100 provides additional energy in the form of heat useful for melting the snow 40 and ice 50.

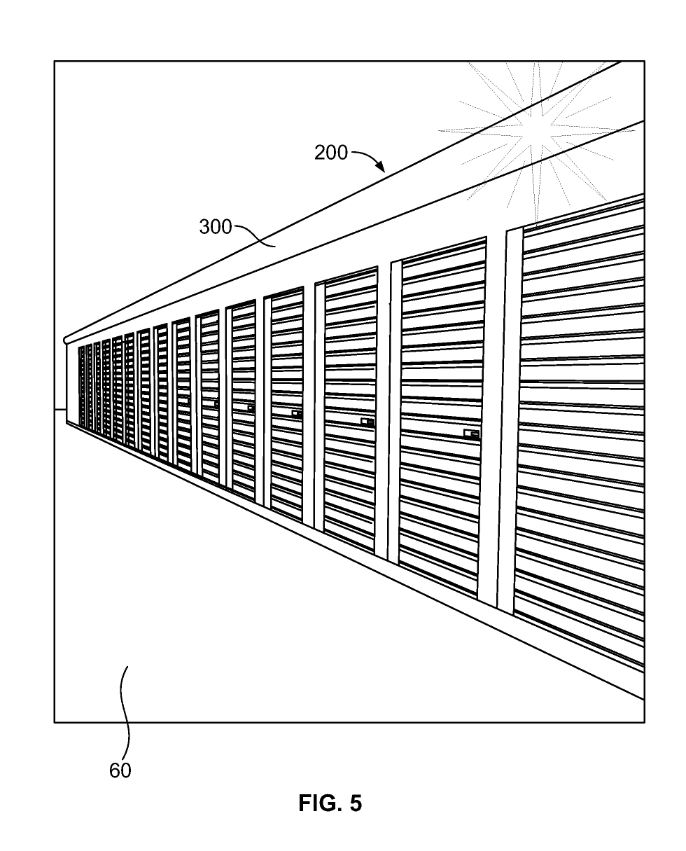

FIG. 5 is a perspective view of building 200 showing reflective panel 300 positioned over the entire length of the gutter of building 200. Another reflective panel may be positioned over gutter 104 of building 100 (shown in FIGS. 1 and 4) so that at a different time of the day sunlight may be reflected towards the road surface 60 in front of building 200, to help melt ice and snow that may be located in on the road surface 60 in front of building 200.

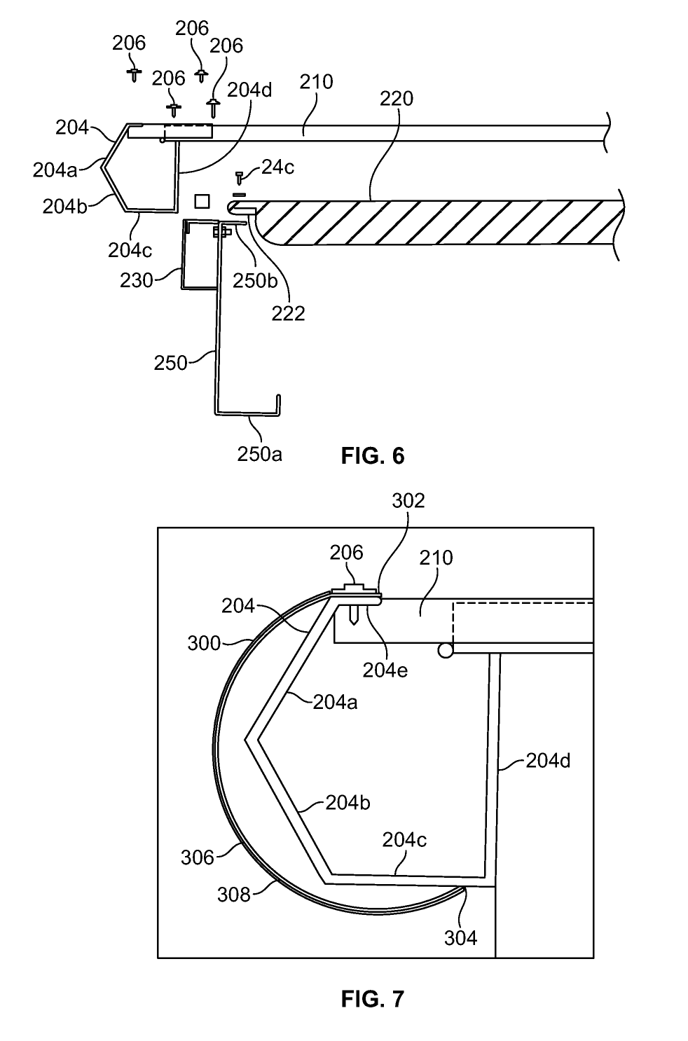

FIG. 6 is a cross-sectional view of a gutter system 204 that may be used on building 200 shown in FIGS. 1-5, and FIG. 7 is a close up cross-sectional view showing sun-reflective panel 300 positioned over gutter 204, according to an example embodiment. As shown in FIGS. 6 and 7, gutter system 204 includes outer walls 204a and 204b, lower wall 204c, and rear wall 204d. Gutter system 204 is open at the top to allow for water to enter the gutter system 204 where it is held within walls 204a-d and directed towards a drain site. Gutter system 204 is secured to building structure 210 with screws 206. A top portion of the reflective panel 300 is secured to building structure 210 and gutter system 204 by inserting screw 206 through upper flange 302 of the reflective panel 300 and through upper flange 204e of gutter system 204 and into building structure 210.

In this manner the top of the reflective panel 300 is held in place, without interfering with the operation of the gutter system 204. However, the bottom portion having an end 304 may rest against the bottom wall 204c of gutter system 204. This mounting system advantageously provides for easy installation of the reflective panel without requiring additional hardware components, as screw 206 is already being used to secure the gutter system 204 to building structure 210. The reflective panel may be comprised of sheet metal typically used for HVAC ducts. Thus, the sheet metal of this type may already have a “curl” to it providing for a desired curved, convex outer surface 306. The outer surface may be circular or curvilinear. In some embodiments the outer surface may be formed as an arc extending more than 180 degrees from a point where it is secured to the gutter system to a point beneath the gutter system. A thin layer of reflective Mylar 308 or other reflective material, such as a mirrored surface, may be adhered to the convex outer surface 306 of reflective panel 300 with contact cement or other adhesive to provide for greater reflectivity.

The reflective panel 300 may also be formed of a plastic or composite material. For example, the reflective panel 300 could be formed as a plastic molding or extrusion, having a reflective surface, which could be manufactured inexpensively, yet provide a desired reflective panel. The reflective surface could be formed by polishing an exterior surface, or by adhering a thin layer of a highly reflective material, such as Mylar, or other mirror-like material that has a high degree of reflectivity. An added highly reflective material could be adhered to the reflective panel using an adhesive such as contact cement, or other suitable adhesive. In addition, the reflective panel 300 may be another metal material such as aluminum or stainless steel that has a highly reflective surface. For example, the outer surface of could be highly polished to provide a high degree of reflectivity. Alternately, a reflective layer could be adhered to the aluminum or stainless steel surface as desired.

The disclosed embodiment may provide additional advantages as well. For example, as the sun 20 sets and lighting fixtures mounted on the north facing building 100 turn on, the reflective panels may now reflect the light generated from the light fixtures providing additional lighting at no additional cost.

Example embodiments have been described above. Those skilled in the art will understand that changes and modifications may be made to the described embodiments without departing from the true scope and spirit of the present invention, which is defined by the claims.

What is claimed is:

1. A device for directing sunlight towards snow or ice, the device comprising:
a panel member configured for attachment to a structure of a building;
said panel member having a reflective surface suitable for reflecting sunlight;
said reflective surface having a curved configuration adapted for directing sunlight towards an adjacent road surface for melting snow or ice on the road surface;
wherein the reflective surface extends continuously as a convex surface from a position above a gutter to a position below the gutter.

2. The device of claim 1, wherein the structure comprises the gutter.

3. The device of claim 2, wherein a top portion of the panel member is secured to a top of the gutter, and a bottom portion extends beneath a bottom of the gutter.

4. The device of claim 3, wherein the bottom portion is movable with respect to the bottom of the gutter allowing a positioning of the reflective surface to be altered.

5. The device of claim 2, wherein the reflective surface comprises a layer of flexible material.

6. The device of claim 2, wherein the curved configuration of the reflective surface is convex.

7. The device of claim 1, wherein the reflective surface is a mirrored surface.

8. The device of claim 1, wherein the curved configuration of the reflective surface is configured to magnify and direct sunlight towards the adjacent road surface.

9. The device of claim 8, wherein the reflective surface comprises a curvilinear and convex surface that extends 180 degrees or more from a point where it is attached to the gutter to a point beneath the gutter.

10. The device of claim 9, wherein the curvilinear and convex reflective surface has a generally constant radius of curvature that does not vary by more than 15 percent in length, along an entire length of the reflective surface.

11. The device of claim 2, wherein a plurality of panel members are positioned on the gutter.

12. A reflective gutter system, comprising:
a gutter secured to a building structure;
a panel member having a top end secured to the gutter of the building;
said panel member having a reflective surface suitable for reflecting sunlight;
said reflective surface having a curved configuration adapted for directing sunlight towards an adjacent road surface for melting snow or ice on the road surface;
wherein the reflective surface extends continuously as a convex surface from a position above a gutter to a position below the gutter.

13. The reflective gutter system of claim 12, wherein the curved configuration is convex.

14. The reflective gutter system of claim 12, wherein the curved configuration includes a mirrored surface for directing sunlight towards the adjacent road surface.

15. The reflective gutter system of claim 12, wherein the curved configuration extends from the top end of the panel member over the gutter to a bottom end of the panel member positioned beneath the gutter.

16. A method of directing sunlight towards a road surface comprising the steps of:
providing a panel member configured for attachment to a structure of a building, said panel member having a reflective surface suitable for reflecting sunlight, and said reflective surface having a curved configuration adapted for directing sunlight towards an adjacent road surface for melting snow or ice on the road surface, and wherein the reflective surface extends continuously as a convex surface from a position above a gutter to a position below the gutter;
securing the panel about a gutter on the structure of the building; and
directing sunlight towards snow or ice positioned on a road surface positioned adjacent the building.

17. The method of claim 16, wherein the step of directing sunlight comprises directing sunlight off of the curved configuration of the reflective surface.

18. The method of claim 17, wherein the reflective surface comprises a layer of flexible material.

19. The method of claim 17, wherein the reflective surface is a mirrored surface.

20. The method of claim 17, wherein the convex reflective surface serves to magnify and direct sunlight towards the road surface positioned in front of the adjacent building.
